(19) United States
(12) Patent Application Publication
(10) Pub. No.: US 2012/0249479 A1
(43) Pub. Date: Oct. 4, 2012

(54) INTERACTIVE INPUT SYSTEM AND IMAGING ASSEMBLY THEREFOR

(75) Inventors: ALEX CHTCHETININE, Calgary (CA); STEPHEN BOLT, Stittsuille (CA); NICOLE MARTIN, Calgary (CA)

(73) Assignee: SMART TECHNOLOGIES ULC, Calgary (CA)

(21) Appl. No.: 13/432,547

(22) Filed: Mar. 28, 2012

Related U.S. Application Data
(60) Provisional application No. 61/470,457, filed on Mar. 31, 2011.

(51) Int. Cl. G06F 3/042

(52) U.S. Cl. 345/175

(57) ABSTRACT

An interactive input system and imaging assembly therefor are disclosed. The imaging assembly includes an image sensor for capturing images of a region of interest; a light source; and a beam splitter. The beam splitter is configured such that optical axes of the image sensor and the light source are generally aligned.

### FIELD OF THE INVENTION

The present invention generally relates to interactive input systems, and in particular to an interactive input system and an imaging assembly therefor.

### BACKGROUND OF THE INVENTION

Interactive input systems that allow users to inject input (i.e. digital ink, mouse events etc.) into an application program using an active pointer (e.g. a pointer that emits light, sound or other signal), a passive pointer (e.g. a finger, cylinder or other suitable object) or other suitable input device such as for example, a mouse or trackball, are known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; 7,274,356 and 7,532,206 assigned to SMART Technologies ULC of Calgary, Alberta, Canada, assignee of the subject application, the entire contents of which are incorporated herein by reference; touch systems comprising touch panels employing electromagnetic, capacitive, acoustic or other technologies to register pointer input; tablet and laptop personal computers (PCs); personal digital assistants (PDAs) and other handheld devices; and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital cameras at its corners. The digital cameras have overlapping fields of view that encompass and look generally across the touch surface. The digital cameras acquire images from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x, y) coordinates relative to the touch surface using triangulation. The pointer coordinates are conveyed to a computer executing one or more application programs. The computer uses the pointer location data to update the computer-generated image that is presented on the touch surface. Pointer contacts on the touch surface can therefore be recorded as writing or drawing or used to control execution of an application program executed by the computer.

In order to facilitate or improve the detection of pointers relative to a touch surface in an interactive input system, various lighting schemes and imaging techniques have been considered. For example, U.S. Pat. No. 7,232,986 to Worthington et al., assigned to SMART Technologies, ULC, discloses a camera-based touch system with a bezel illuminated by at least one light source, such as an array of infrared (IR) light emitting diodes (LEDs). Each light source is associated with and positioned adjacent each digital camera. The bezel can be retro-reflectors that reflect the infrared light back towards the digital cameras. As a result, each camera sees a bright band of illumination within its field of view. When a pointer is positioned within the fields of view of the digital camera, the pointer occludes the infrared illumination and therefore appears as a high-contrast dark region interrupting a bright band of illumination (a shadow of the pointer) in each captured image allowing the existence of the pointer in the captured images to be readily detected.

U.S. Patent Application Publication No. US 2009/0278795 to Hansen et al. entitled “Interactive Input System and Illumination Assembly” filed on May 9, 2008, assigned to SMART Technologies, discloses an illumination assembly for an interactive input system. The illumination assembly comprises at least two radiation sources directing radiation into a region of interest. Each of the radiation sources has a different emission angle. The at least two radiation sources are mounted on a board positioned over an associated image sensor. The illumination from the radiation sources with wide emission angle covers the entire region of the interest while illumination from the radiation source with narrow emission angle is directed towards the portions of the bezel segments that meet at the opposite diagonal corner of the display so that the bezel segments are substantially evenly illuminated.

U.S. Patent Application Publication No. 2009/0213093 to Bridger discloses an optical position sensing system including a plurality of radiation sources. The position of the radiation sources may be varied with respect to the aperture to achieve performance enhancement. Supplemental radiation sources may be positioned around the bezel so as to provide supplemental backlighting. Each of the plurality of supplemental radiation sources can be individually activated and deactivated, so as to selectively provide the supplemental backlighting to one or more selected areas within the bezel.

U.S. Patent Application Publication No. 2009/0213094 to Bridger discloses an optical position sensing assembly including a body. An optical sensor is mounted to a rear face of the body and a radiation source is positioned within the body above the lens. A light path separator is positioned between the radiation source and an image window for the optical sensor, so that the radiation path is optically separated from the view path of the optical sensor. In this way, a compact, robust and cost efficient device can be achieved.

U.S. Pat. No. 6,429,856 to Omura et al., discloses a coodinate-position inputting/detecting device comprising light receiving/emitting devices emitting light beams spreading in a fan shape and travelling along an entry area. The light receiving/emitting device also receives the light beam reflected by a recursive reflecting member, and detects the distribution of the intensity of the received light beam. The coordinates of a position of a pointing body such as a user's fingertip or a pen inserted in the entry area is identified using the distribution of intensity detected by the light receiving/emitting devices.

U.S. Pat. No. 6,441,362 to Ogawa discloses an optical digitizer constructed for determining a position of a pointing object projecting a light and being disposed on a coordinate plane. In the optical digitizer, a detector is disposed on a periphery of the coordinate plane and has a view field covering the coordinate plane for receiving light projected from the pointing object and for converting the received light into an electric signal. A processor is provided for processing the electric signal fed from the detector to compute coordinates representing the position of the pointing object. A collimator is disposed to limit the view field of the detector below a predetermined height relative to the coordinate plane such that through the limited view field the detector can receive only a parallel component of the light which is projected from the pointing object substantially in parallel to the coordinate plane. A shield is disposed to enclose the periphery of the coordinate plane to block a noise light other than the projected light from entering into the limited view field of the detector.

Some of the interactive input systems mentioned above employ one or more light sources mounted above, below, or laterally adjacent an associated image sensor. In such arrangements, the light emitted by the light sources is at an angle slightly off-axis to the optical axis of the image sensor. For example, FIGS. 1 and 2 show prior art imaging assemblies 160′ and 160″, respectively, that are configured for being positioned adjacent a corner of an interactive surface 124′ and 124″, respectively. Each of the imaging assemblies 160′ and 160″ comprises a respective light source 166′ and 166″ and a respective image sensor 164′ and 164″, where the light source is in the form of a light emitting diode. In FIG. 1, light source 166′ is mounted laterally adjacent the image sensor 164′, with respect to the plane of interactive surface 124′. In FIG. 2, light source 166″ is mounted below the image sensor 164″, with respect to the plane of interactive surface 124″. In both cases, light source 166′ or 166″ will cast a shadow of a pointer brought into proximity with the interactive surface, and this shadow may be imaged by the image sensor. As will be appreciated, this shadow may interfere with the process of accurately determining the pointer position from image frames captured by the image sensor.

It is therefore an object of the present invention to provide a novel interactive input system and an imaging assembly therefor.

### SUMMARY OF THE INVENTION

Accordingly, in one aspect there is provided an imaging assembly for an interactive input system comprising an image sensor for capturing images of a region of interest; a light source; and a beam splitter, wherein the beam splitter is configured such that optical axes of the image sensor and the light source are generally aligned.

In one embodiment, the light source comprises at least one light emitting diode. In another embodiment, the light source is an infrared light source. In another embodiment, the imaging assembly further comprises a tuned lens positioned between the light source and the beam splitter. In still another embodiment, the imaging assembly is configured to provide illumination having a fan-shaped profile.

In another embodiment, the optical axes of the image sensor and the light source define an acute angle. In another embodiment, the beam splitter is any of a half-mirror plate, a customer designed coating plate, a cube beam splitter, and a grating. In another embodiment, the imaging assembly further comprises a two-element lens system. In another embodiment, the imaging assembly further comprises a mirror. In another embodiment, the light source is positioned below an interactive surface of the interactive input system.

In another aspect, there is provided an interactive input system comprising at least one imaging assembly comprising an image sensor capturing images of a region of interest; a light source; and a beam splitter, wherein the beam splitter is configured such that optical axes of the image sensor and the light source are generally aligned.

In one embodiment, the region of interest is surrounded at least partially by a retro-reflective bezel. In another embodiment, the interactive input system further comprises processing structure in communication with the image sensor processing captured images for locating a pointer positioned in proximity with the region of interest.

In another embodiment, the light source comprises at least one light emitting diode. In another embodiment, the light source is an infrared light source.

In another embodiment, the imaging assembly further comprises a tuned lens and positioned between the light source and the beam splitter. In another embodiment, the imaging assembly further comprises a diffuser positioned between the light source and the beam splitter. In another embodiment, the imaging assembly is configured to provide illumination having a fan-shaped profile. In another embodiment, the optical axes of the image sensor and the light source form an acute angle. In another embodiment, the beam splitter is any of a half-mirror plate, a custom-designed coating plate, a cube beam splitter, and a grating. In another embodiment, the imaging assembly further comprises a two-element lens system. In another embodiment, the imaging assembly further comprises a mirror. In another embodiment, the light source is positioned below an interactive surface of the interactive input system.

### BRIEF DESCRIPTION OF THE DRAWINGS

Embodiments will now be described more fully with reference to the accompanying drawings in which:

FIG. 1 is a schematic top plan view of an embodiment of a prior art imaging assembly for use with an interactive input system;

FIG. 2 is a schematic side elevational view of another prior art imaging assembly for use with an interactive input system;

FIG. 3 is a schematic, partial perspective view of an interactive input system;

FIG. 4 is a schematic view of the interactive input system of FIG. 3;

FIG. 5 is a block diagram of components of an imaging assembly forming part of the interactive input system of FIG. 3;

FIG. 6 is a block diagram of components of a master controller forming part of the interactive input system of FIG. 3;

FIG. 7 is a schematic side elevational view including the imaging assembly of FIG. 5;

FIG. 8 is a schematic top plan view including the imaging assembly of FIG. 5;

FIG. 9 is a schematic side elevational view including another embodiment of an imaging assembly forming part of the interactive input system of FIG. 3;

FIG. 10 is a schematic top plan view including still another embodiment of an imaging assembly forming part of the interactive input system of FIG. 3;

FIG. 11 is a schematic side elevational view including yet another embodiment of an imaging assembly forming part of the interactive input system of FIG. 3;

FIG. 12 is a schematic top plan view including the imaging assembly of FIG. 11;

FIG. 13 is a schematic side elevational view including still yet another embodiment of an imaging assembly forming part of the interactive input system of FIG. 3;

FIG. 14 is a schematic side elevational view including still another embodiment of an imaging assembly forming part of the interactive input system of FIG. 3;

FIG. 15 is a schematic side elevational view including yet another embodiment of an imaging assembly forming part of the interactive input system of FIG. 3;

FIG. 16 is a schematic view of another embodiment of an interactive input system; and

FIG. 17 is a schematic view of another embodiment of an interactive board forming part of the interactive input system of FIG. 16.

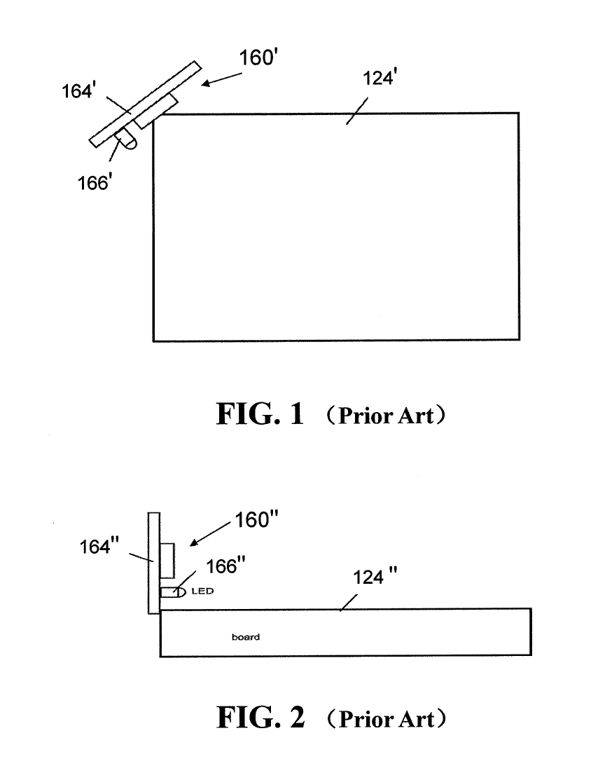

### DETAILED DESCRIPTION OF THE EMBODIMENTS

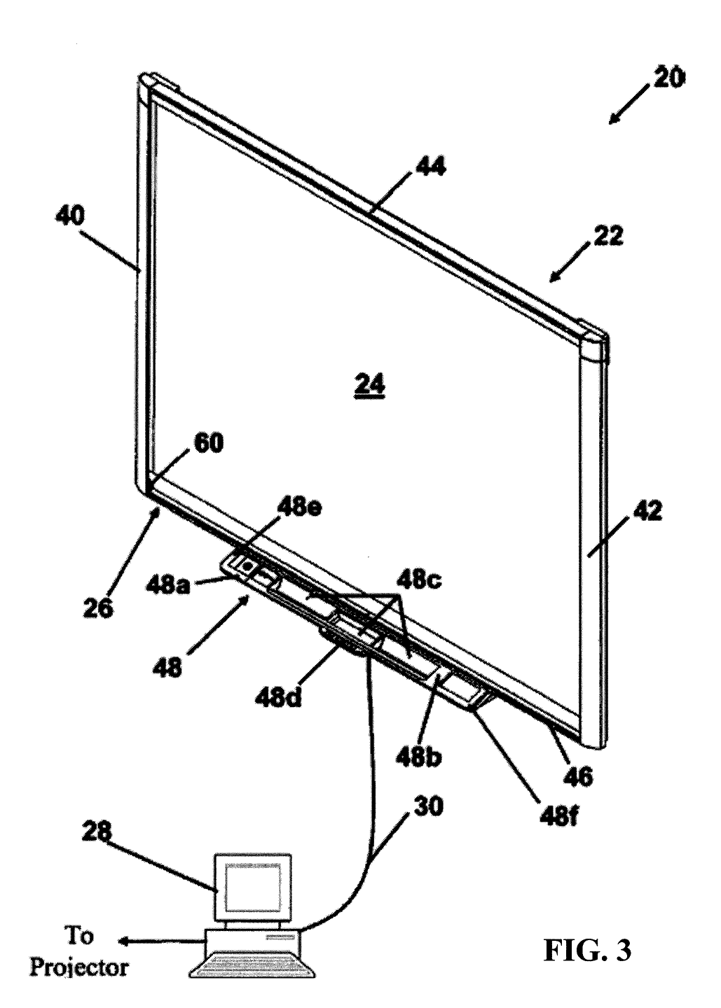

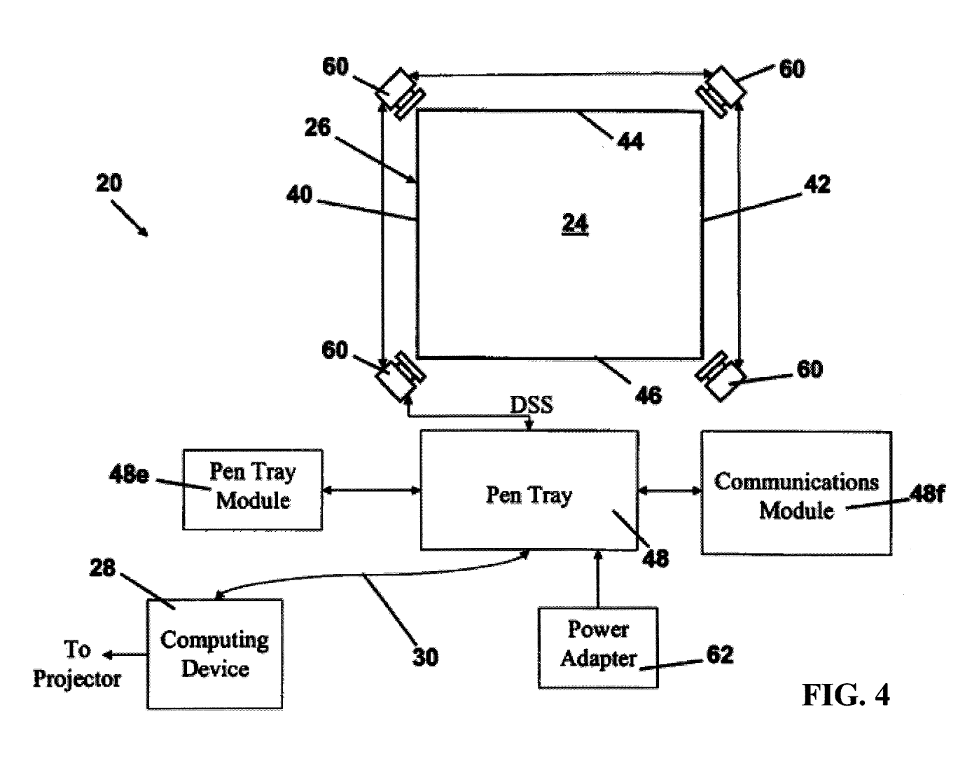

Turning now to FIGS. 3 and 4, an interactive input system that allows a user to inject input such as digital ink, mouse events etc. into an application program executed by a computing device is shown and is generally identified by reference numeral 20. In this embodiment, interactive input system 20 comprises an interactive board 22 mounted on a vertical support surface such as for example, a wall surface or the like. Interactive board 22 comprises a generally planar, rectangular interactive surface 24 that is surrounded about its periphery by a bezel 26. An ultra-short throw projector (not shown) such as that sold by SMART Technologies ULC under the name SMART UX60 is also mounted on the support surface above the interactive board 22 and projects an image, such as for example a computer desktop, onto the interactive surface 24.

The interactive board 22 employs machine vision to detect one or more pointers brought into a region of interest in proximity with the interactive surface 24. The interactive board 22 communicates with a general purpose computing device 28 executing one or more application programs via a universal serial bus (USB) cable 30. General purpose computing device 28 processes the output of the interactive board 22 and adjusts image data that is output to the projector, if required, so that the image presented on the interactive surface 24 reflects pointer activity. In this manner, the interactive board 22, general purpose computing device 28 and projector allow pointer activity proximate to the interactive surface 24 to be recorded as writing or drawing or used to control execution of one or more application programs executed by the general purpose computing device 28.

The bezel 26 in this embodiment is mechanically fastened to the interactive surface 24 and comprises four bezel segments 40, 42, 44, 46. Bezel segments 40 and 42 extend along opposite side edges of the interactive surface 24 while bezel segments 44 and 46 extend along the top and bottom edges of the interactive surface 24 respectively. In this embodiment, the inwardly facing surface of each bezel segment 40, 42, 44 and 46 comprises a single, longitudinally extending strip or band of retro-reflective material. To take best advantage of the properties of the retro-reflective material, the bezel segments 40, 42, 44 and 46 are oriented so that their inwardly facing surfaces extend in a plane generally normal to the plane of the interactive surface 24.

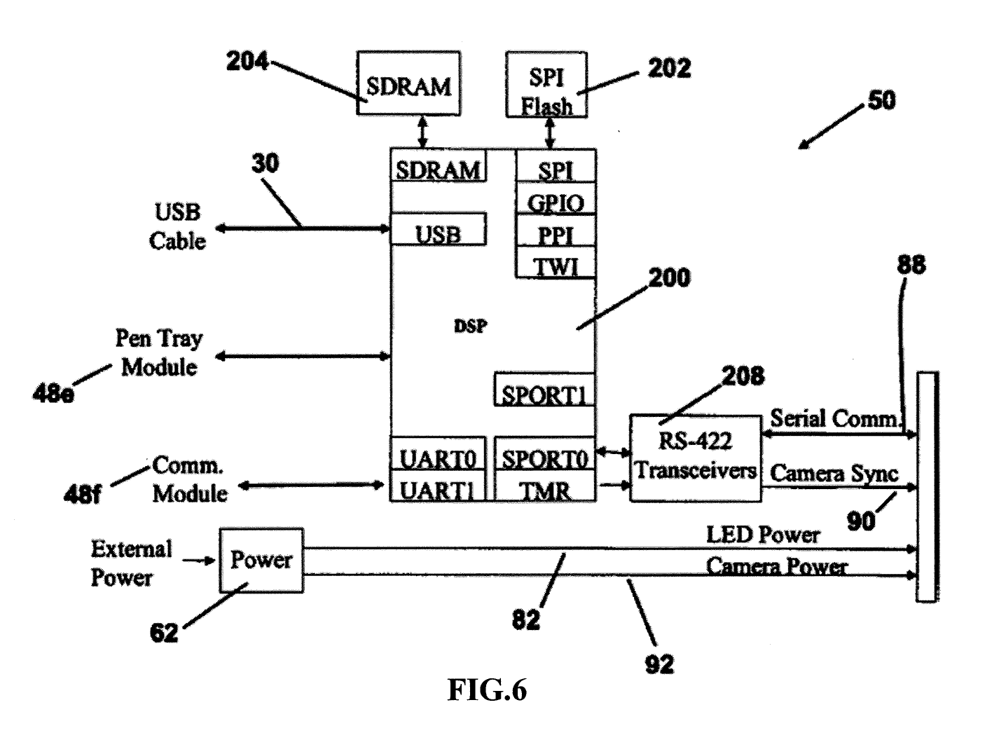

A tool tray 48 is affixed to the interactive board 22 adjacent the bezel segment 46 using suitable fasteners such as for example, screws, clips, adhesive etc. As can be seen, the tool tray 48 comprises a housing 48a having an upper surface 48b configured to define a plurality of receptacles or slots 48c. The receptacles 48c are sized to receive one or more pen tools P as will be described as well as an eraser tool (not shown) that can be used to interact with the interactive surface 24. Control buttons 48d are provided on the upper surface 48b of the housing 48a to enable a user to control operation of the interactive input system 20. One end of the tool tray 48 is configured to receive a detachable tool tray accessory module 48e while the opposite end of the tool tray 48 is configured to receive a detachable communications module 48f for remote device communications. The housing 48a accommodates a master controller 50 (see FIG. 6) as will be described. Further specifics of the tool tray 48 are described in U.S. Patent Application Publication No. 2011/0169736 to Bolt et al. entitled “Interactive Input System and Pen Tool Tray Therefor” filed Feb. 19, 2010, the content of which is incorporated herein by reference in its entirety.

As shown in FIG. 4, imaging assemblies 60 are accommodated by the bezel 26, with each imaging assembly 60 being positioned adjacent a different corner of the bezel. The imaging assemblies 60 are oriented so that their fields of view overlap and look generally across the entire interactive surface 24. In this manner, any pointer such as for example a user's finger, a cylinder or other suitable object, or a pen tool or eraser tool lifted from a receptacle 48c of the tool tray 48, that is brought into proximity of the interactive surface 24 appears in the fields of view of the imaging assemblies 60. A power adapter 62 provides the necessary operating power to the interactive board 22 when connected to a conventional AC mains power supply.

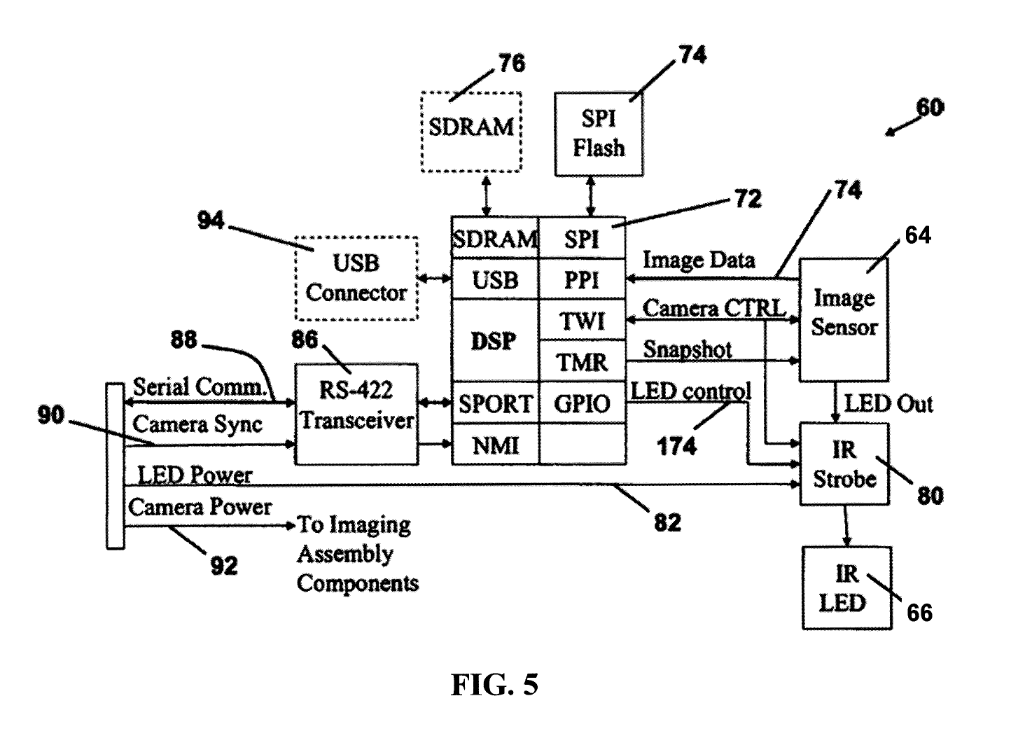

Turning now to FIG. 5, some components of one of the imaging assemblies 60 are illustrated. As can be seen, the imaging assembly 60 comprises an image sensor 64 such as that manufactured by Aptina (Micron) under Model No. MT9V034 having a resolution of 752×480 pixels, fitted with a two element, plastic lens (not shown) that provides the image sensor 64 with a field of view of approximately 104 degrees. In this manner, the other imaging assemblies 60 are within the field of view of the image sensor 64 thereby to ensure that the field of view of the image sensor 64 encompasses the entire interactive surface 24.

A digital signal processor (DSP) 72 such as that manufactured by Analog Devices under part number ADSP-BF522 Blackfin or other suitable processing device, communicates with the image sensor 64 over an image data bus 74 via a parallel port interface (PPI). A serial peripheral interface (SPI) flash memory 74 is connected to the DSP 72 via an SPI port and stores the firmware required for image assembly operation. Depending on the size of captured image frames as well as the processing requirements of the DSP 72, the imaging assembly 60 may optionally comprise synchronous dynamic random access memory (SDRAM) 76 to store additional temporary data as shown by the dotted lines. The image sensor 64 also communicates with the DSP 72 via a two-wire interface (TWI) and a timer (TMR) interface. The control registers of the image sensor 64 are written from the DSP 72 via the TWI in order to configure parameters of the image sensor 64 such as the integration period for the image sensor 64.

In this embodiment, the image sensor 64 operates in snapshot mode. In the snapshot mode, the image sensor 64, in response to an external trigger signal received from the DSP 72 via the TMR interface that has a duration set by a timer on the DSP 72, enters an integration period during which an image frame is captured. Following the integration period after the generation of the trigger signal by the DSP 72 has ended, the image sensor 64 enters a readout period during which time the captured image frame is available. With the image sensor in the readout period, the DSP 72 reads the image frame data acquired by the image sensor 64 over the image data bus 74 via the PPI. The frame rate of the image sensor 64 in this embodiment is between about 900 and about 960 frames per second. The DSP 72 in turn processes image frames received from the image sensor 72 and provides pointer information to the master controller 50 at a reduced rate of approximately 120 points/sec. Those of skill in the art will however appreciate that other frame rates may be employed depending on the desired accuracy of pointer tracking and whether multi-touch and/or active pointer identification is employed.

A strobe circuit 80 communicates with the DSP 72 via the TWI and via a general purpose input/output (GPIO) interface. The IR strobe circuits 80 also communicate with the image sensor 64 and receive power provided on LED power line 82 via the power adapter 52. The strobe circuit 80 drives a respective infrared (IR) light source 66 in the form of an IR light emitting diode (LED) that provides infrared backlighting over the interactive surface 24. Further specifics concerning the strobe circuits 80 and their operation are described in U.S. Patent Application Publication No. 2011/0169727 to Akitt entitled “Interactive Input System and Illumination System Therefor” filed on Feb. 19, 2010, the content of which is incorporated herein by reference in its entirety.

The DSP 72 also communicates with an RS-422 transceiver 86 via a serial port (SPORT) and a non-maskable interrupt (NMI) port. The transceiver 86 communicates with the master controller 50 over a differential synchronous signal (DSS) communications link 88 and a synch line 90. Power for the components of the imaging assembly 60 is provided on power line 92 by the power adapter 52. DSP 72 may also optionally be connected to a USB connector 94 via a USB port as indicated by the dotted lines. The USB connector 94 can be used to connect the imaging assembly 60 to diagnostic equipment.

Components of the master controller 50 are illustrated in FIG. 6. As can be seen, master controller 50 comprises a DSP 200 such as that manufactured by Analog Devices under part number ADSP-BF522 Blackfin or other suitable processing device. A serial peripheral interface (SPI) flash memory 202 is connected to the DSP 200 via an SPI port and stores the firmware required for master controller operation. A synchronous dynamic random access memory (SDRAM) 204 that stores temporary data necessary for system operation is connected to the DSP 200 via an SDRAM port. The DSP 200 communicates with the general purpose computing device 28 over the USB cable 30 via a USB port. The DSP 200 communicates through its serial port (SPORT) with the imaging assemblies 60 via an RS-422 transceiver 208 over the differential synchronous signal (DSS) communications link 88. In this embodiment, as more than one imaging assembly 60 communicates with the master controller DSP 200 over the DSS communications link 88, time division multiplexed (TDM) communications is employed. The DSP 200 also communicates with the imaging assemblies 60 via the RS-422 transceiver 208 over the camera synch line 90. DSP 200 communicates with the tool tray accessory module 48e over an inter-integrated circuit I²C channel and communicates with the communications accessory module 48f over universal asynchronous receiver/transmitter (UART), serial peripheral interface (SPI) and I²C channels.

As will be appreciated, the component architectures of the imaging assemblies 60 and the master controller 50 are similar. As will be appreciated therefore, the same circuit board assembly and common components may be used for both the imaging assemblies 60 and the master controller 50, thus reducing the differing part count and cost of the interactive input system. Differing components are added to the circuit board assemblies during manufacture dependent upon whether the circuit board assembly is intended for use in an imaging assembly 60 or in the master controller 50. For example, the master controller 50 may require a SDRAM 176 whereas the imaging assembly 60 may not.

The general purpose computing device 28 in this embodiment is a personal computer or other suitable processing device comprising, for example, a processing unit, system memory (volatile and/or non-volatile memory), other non-removable or removable memory (e.g. a hard disk drive, RAM, ROM, EEPROM, CD-ROM, DVD, flash memory, etc.) and a system bus coupling the various computer components to the processing unit. The computer may also comprise a network connection to access shared or remote drives, one or more networked computers, or other networked devices.

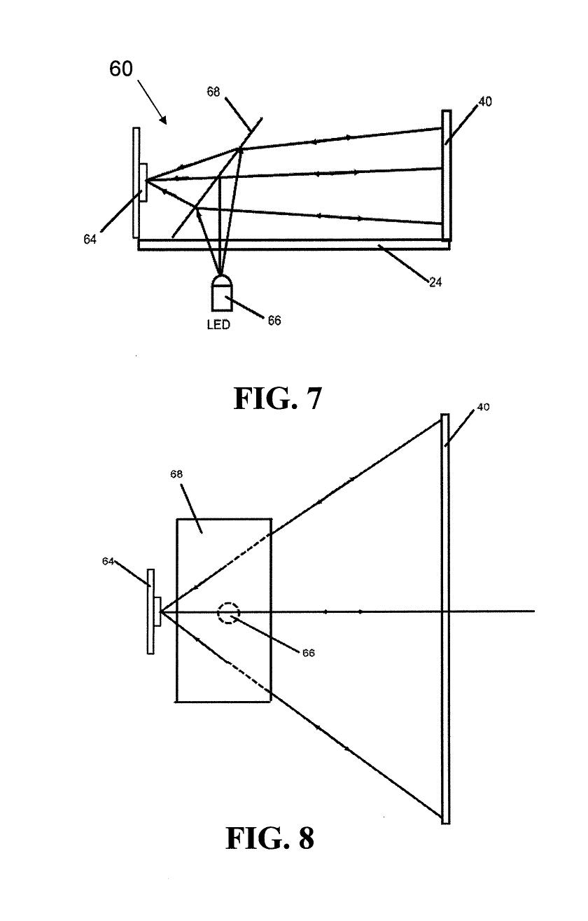

FIGS. 7 and 8 schematically illustrate an imaging assembly 60 and its position in the interactive input system. In this embodiment, IR light source 66 and image sensor 64 are positioned within imaging assembly 60 such that their optical axes are generally perpendicular, as shown. Imaging assembly 60 also comprises a beam splitter 68 positioned adjacent to the IR light source 66 and the image sensor 64. In this embodiment, beam splitter 68 is a 50/50 half-mirror at the wavelength emitted by the IR light source 66, and is oriented at a generally forty-five (45) degree angle to the optical axes of both the IR light source 66 and the image sensor 64. Beam splitter 68 is thereby configured to redirect illumination emitted by light source 66 generally across the interactive surface 24 and towards any of bezel segments 40 to 46. Image sensor 64 is positioned such that redirected illumination that is reflected by the retro-reflective surface of bezel segments 40 to 46 will be partially transmitted through beam splitter 68 to image sensor 64. In this manner, the optical axes of the image sensor 64 and the IR light source 66 are generally aligned.

When a pointer is brought into proximity with the interactive surface 24 during use, illumination emitted by IR light source 66 will cast a shadow of the pointer. As will be understood, by aligning the optical axes of the image sensor 64 and the IR light source 66, any such shadow will be either less visible to, or not seen by, the image sensor 64. As will be appreciated, this advantageously allows the positions of pointers to be more accurately determined from image frames captured by image sensor 64.

Additionally, as IR light source 66 is positioned below interactive surface 24, imaging assembly 60 is more compact than prior art imaging assemblies in which one or more light sources are positioned above the interactive surface. As will be appreciated, this reduces the height of the imaging assembly 60, and advantageously allows the imaging assembly 60 to be used with a bezel of reduced height.

During operation, the DSP 200 of the master controller 50 outputs synchronization signals that are applied to the synch line 90 via the transceiver 208. Each synchronization signal applied to the synch line 90 is received by the DSP 72 of each imaging assembly 60 via transceiver 86 and triggers a non-maskable interrupt (NMI) on the DSP 72. In response to the non-markable interrupt triggered by the synchronization signal, the DSP 72 of each imaging assembly 60 ensures that its local timers are within system tolerances and if not, corrects its local timers to match the master controller 50. Using one local timer, the DSP 72 initiates a pulse sequence via the snapshot line that is used to direct the image sensor in the snapshot mode and to control the integration period and frame rate of the image sensor 64 in the snapshot mode. The DSP 72 also initiates a second local timer that is used to provide output on the LED control line 174 so that the light source 66 is properly powered during the image frame capture cycle.

In response to the pulse sequence output on the snapshot line, the image sensor 64 of each imaging assembly 60 acquires image frames at the desired image frame rate. In this manner, image frames captured by the image sensor 64 of each imaging assembly 60 can be referenced to the same point of time allowing the position of pointers brought into the fields of view of the image sensors 64 to be accurately triangulated. Also, by distributing the synchronization signals for the imaging assemblies 60, electromagnetic interference is minimized by reducing the need for transmitting a fast clock signal to each image assembly 60 from a central location. Instead, each imaging assembly 60 has its own local oscillator (not shown) and a lower frequency signal (e.g. the point rate, 120 Hz) is used to keep the image frame capture synchronized.

During image frame capture, the DSP 72 of each imaging assembly 60 also provides output to the strobe circuit 80 to control the IR light source 66 so that the IR LEDs are illuminated in a given sequence that is coordinated with the image frame capture sequence of each image sensor 64. During the image capture sequence, when each IR LED of the IR light source 66 is on, the IR LED floods the region of interest over the interactive surface 24 with infrared illumination. Infrared illumination that impinges on the retro-reflective bands of bezel segments 40, 42, 44 and 46 is returned to the imaging assemblies 60. As a result, in the absence of a pointer, the image sensor 64 of each imaging assembly 60 sees a bright band having a substantially even intensity over its length together with any ambient light artifacts. When a pointer is brought into proximity with the interactive surface 24, the pointer occludes infrared illumination reflected by the retro-reflective bands of bezel segments 40, 42, 44 and 46. As a result, the image sensor 64 of each imaging assembly 60 sees a dark region that interrupts the bright band in captured image frames. The reflections of the illuminated retro-reflective bands of bezel segments 40 to 46 are also visible to the image sensor 64.

The sequence of image frames captured by the image sensor 70 of each imaging assembly 60 is processed by the DSP 72 to identify each pointer in each image frame and to obtain pointer shape and contact information as described in PCT Application No. WO/2011/085479 to McGibney et al., the contents of which are incorporated entirely herein. The DSP 72 of each imaging assembly 60 in turn conveys the pointer data to the DSP 200 of the master controller 50. The DSP 200 uses the pointer data received from the DSPs 72 to calculate the position of each pointer relative to the interactive surface 24 in (x,y) coordinates using well known triangulation as described in above-incorporated U.S. Pat. No. 6,803,906 to Morrison. This pointer coordinate data along with pointer shape and pointer contact status data is conveyed to the general purpose computing device 28 allowing the image data presented on the interactive surface 24 to be updated.

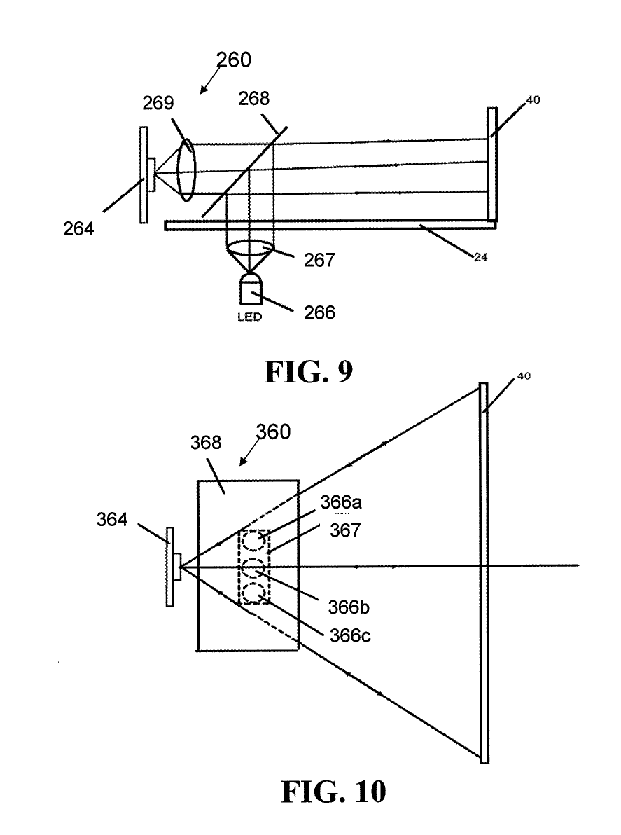

The interactive input system 20 is not limited to use only with the imaging assembly 60 described above and, in other embodiments, other imaging assemblies may alternatively be used. For example, FIG. 9 shows another embodiment of an imaging assembly for use with the interactive input system 20, which is generally indicated by reference numeral 260. Imaging assembly 260 is similar to imaging assembly 60 described above, and comprises an IR light source 266 and an image sensor 264 that are positioned such that their optical axes are generally perpendicular. As will be appreciated, it is desirable for illumination emitted by the IR light source to have a “fan-shaped” profile, so as to more uniformly illuminate the bezel segments. Here, a “fan-shaped” profile comprises a generally uniform distribution of illumination over a wide range of angles within a plane parallel to the interactive surface 24, and a generally uniform distribution of illumination over a narrow range of angles within a plane perpendicular to the interactive surface 24. To achieve a “fan-shaped” profile, imaging assembly 260 comprises a tuned lens 267 positioned between IR light source 266 and half mirror 268. Tuned lenses are referred to in U.S. Patent Application Publication No. 2009/0278795 to Hansen et al., entitled “Interactive Input System and Illumination Assembly” filed on May 9, 2008, assigned to SMART Technologies, ULC, the content of which is incorporated herein by reference in its entirety. In this embodiment, tuned lens 267 comprises two parabolic surfaces, and is shaped so as to partially collimate illumination emitted by IR light source 266 thereby to provide a “fan-shaped” profile. Imaging assembly 260 also comprises a tuned lens 269 that is shaped similarly to tuned lens 267. Tuned lens 269 is positioned so as to focus illumination transmitted through half mirror 268 onto image sensor 264.

Imaging assembly 260 further comprises a beam splitter 268 positioned generally adjacent to the image sensor 264 and the IR light source 266. In this embodiment, beam splitter 268 is a 50/50 half-mirror at the wavelength emitted by the IR light source 266, and is oriented at a generally forty-five (45) degree angle to the optical axes of both the IR light source 266 and the image sensor 264. Beam splitter 268 is configured to redirect illumination emitted by light source 266 generally across the interactive surface 24 and towards any of bezel segments 40 to 46. Image sensor 264 is positioned such that redirected illumination that is reflected by the retro-reflective surface of bezel segments 40 to 46 will be partially transmitted through beam splitter 268 to image sensor 264. In this manner, the optical axes of the image sensor 264 and the IR light source 266 are generally aligned.

FIG. 10 shows another embodiment of an imaging assembly for use with the interactive input system 20, and which is generally indicated by reference numeral 360. Imaging assembly 360 is generally similar to imaging assembly 60 described above, and comprises an IR light source 366 and an image sensor 364 that are positioned such that their optical axes are generally perpendicular. In this embodiment, IR light source 366 comprises a plurality of light emitting diodes (LEDs) 366a to 366c arranged along a linear axis, as shown. As will be appreciated, by arranging LEDs 366a to 366c in this manner, IR light source 366 provides illumination having a high intensity over a range of angles lying within a plane parallel with the linear axis of the series. Imaging assembly 360 also comprises a diffuser 367 positioned adjacent IR light source 366. Diffuser 367 is shaped so as to partially collimate illumination emitted by IR light source 366. The use of diffuser 367 together with LEDs 366a to 366c arranged along a linear axis enables IR light source 366 to emit illumination over a generally “fan-shaped” profile so as to more uniformly illuminate the bezel.

Imaging assembly 360 further comprises a beam splitter 368 positioned generally adjacent to the image sensor 364, the IR light source 366 and the diffuser 367. In this embodiment, beam splitter 368 is a 50/50 half-mirror at the wavelength emitted by the IR light source 366, and is oriented at a generally forty-five (45) degree angle to the optical axes of both IR light source 366 and image sensor 364. Beam splitter 368 is configured to redirect illumination emitted by light source 366 generally across the interactive surface 24 and towards any of bezel segments 40 to 46. Image sensor 364 is positioned such that redirected illumination that is reflected by the retro-reflective surface of bezel segments 40 to 46 will be partially transmitted through beam splitter 368 to image sensor 364. In this manner, the optical axes of the image sensor 364 and the IR light source 366 are generally aligned.

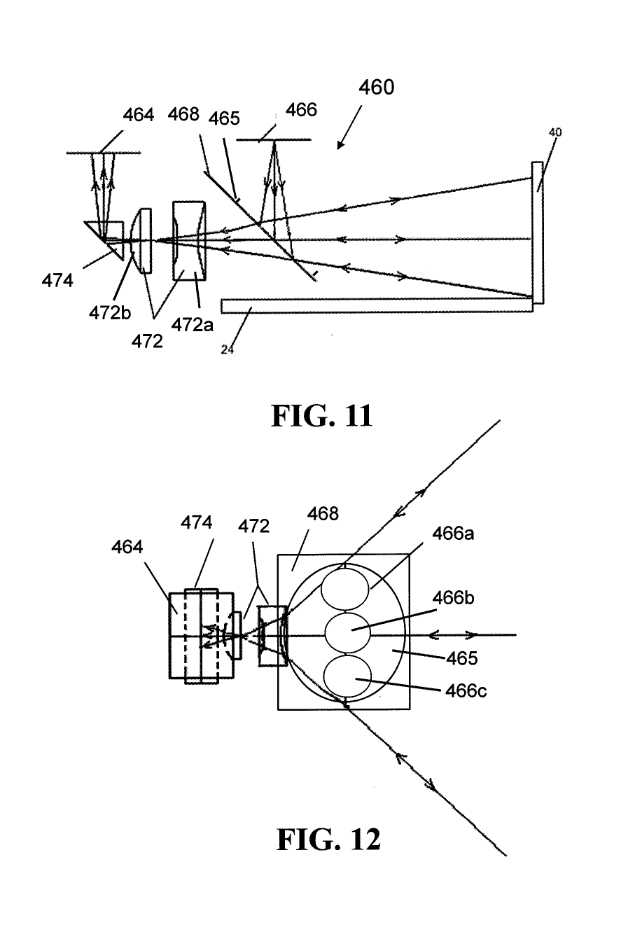

FIGS. 11 and 12 schematically show another embodiment of an imaging assembly for use with the interactive input system 20, and which is generally indicated by reference numeral 460. Imaging assembly 460 is similar to imaging assembly 60 described above, and comprises an IR light source 466 and an image sensor 464 that are positioned such that their optical axes are generally parallel. IR light source 466 comprises a plurality of light emitting diodes (LEDs) 466a to 466c arranged along a linear axis, as shown. Imaging assembly 460 also comprises a beam splitter 468 positioned generally adjacent to the IR light source 466. In this embodiment, beam splitter 468 is a refractive element having a coated surface, and generally functions as a 50/50 half-mirror at the wavelength emitted by the IR light source 466. In this embodiment, imaging assembly 460 also comprises an aperture 465 positioned between IR light source 466 and beam splitter 468. Here, aperture 465 is a circular aperture that prevents illumination emitted by IR light source 466 in directions outside of an angular cone extending between IR light source 466 and the aperture from reaching beam splitter 468. However, it will be understood that aperture 465 is not limited to this position and in other embodiments may be positioned elsewhere within the imaging assembly, between an optical path of IR light source 466 and image sensor 464.

Beam splitter 468 is oriented at a generally forty-five (45) degree angle to the optical axis of IR light source 466. Beam splitter 468 is configured to redirect illumination emitted by IR light source 466 generally across the interactive surface 24 and towards any of bezel segments 40 to 46. Imaging assembly 460 also comprises a two-element lens system 472 positioned adjacent beam splitter 468. In this embodiment, two-element lens system 472 comprises a biconcave lens 472a and a plano-convex lens 472b arranged in series, as shown. Imaging assembly 460 also comprises a triangular prism 474 positioned adjacent to the two-element lens system 472 and the image sensor 464. Image sensor 464, two-element lens system 472 and triangular prism 474 are positioned such that redirected illumination that is reflected by the retro-reflective surface of bezel segments 40 to 46 is partially transmitted through beam splitter 468, and is further transmitted through two-element lens system 472 and into triangular prism 474, where it is redirected to image sensor 464. In this manner, the optical axes of both IR light source 466 and image sensor 464 are generally aligned. As will be appreciated, by positioning IR light source 466 and image sensor 464 adjacently, components of imaging assembly 460 may advantageously be accommodated within a smaller volume.

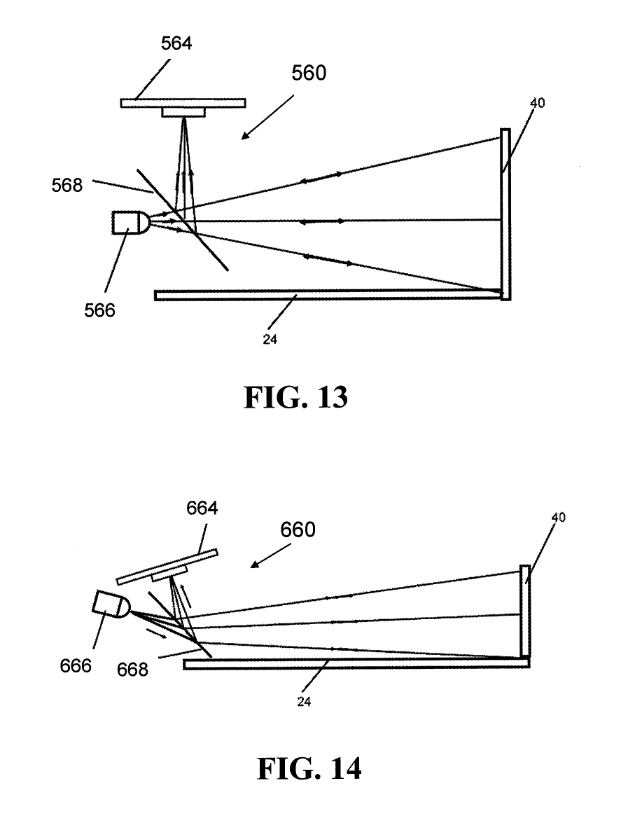

FIG. 13 shows another embodiment of an imaging assembly for use with the interactive input system 20, and which is generally indicated by reference numeral 560. Imaging assembly 560 is generally similar to imaging assembly 60 described above, and comprises an IR light source 566 and image sensor 564 that are positioned within imaging assembly 560 such that their optical axes are generally perpendicular, as shown. Imaging assembly 560 also comprises a beam splitter 568 positioned adjacent to the IR light source 566 and the image sensor 564. In this embodiment, beam splitter 568 is a 50/50 half-mirror at the wavelength emitted by the IR light source 566, and is oriented at a generally forty-five (45) degree angle to the optical axes of IR light source 566 and image sensor 564. Light source 566 is positioned to emit illumination through beam splitter 568 and in a direction generally across the interactive surface 24 and towards any of bezel segments 40 to 46. Beam splitter 568 is configured to redirect illumination that is reflected by the retro-reflective surface of bezel segments 40 to 46 to image sensor 564. In this manner, the optical axes of the image sensor 564 and the IR light source 566 are generally aligned.

In this embodiment, IR light source 566 comprises a single LED. However, in alternative embodiments the IR light source 566 may comprise multiple LEDs, such as in imaging assemblies 360 and 460 described above and with reference to FIGS. 10 to 12.

FIG. 14 shows another embodiment of an imaging assembly for use with the interactive input system 20, and which is generally indicated by reference numeral 660. Imaging assembly 660 is similar to imaging assembly 560 described above and with reference to FIG. 13, and comprises an IR light source 666 and an image sensor 664 that are positioned such that their optical axes generally define an acute angle, as shown schematically in FIG. 14. Imaging assembly 660 also comprises a beam splitter 668 positioned generally adjacent to the IR light source 666 and the image sensor 664. Beam splitter 668 is oriented at an angle that generally bisects the acute angle defined by the optical axes of IR light source 666 and image sensor 664, as shown. Beam splitter 668 is a refractive element having a coated surface, and generally functions as a partial mirror. Here, the coated surface may be selected so as to enable beam splitter 668 to function as a 50/50 half mirror, both at the orientation relative to IR light source 666 and sensor 664 and at the wavelength emitted by the IR light source 666.

Light source 666 is positioned to emit illumination through beam splitter 668 and in a direction generally across the interactive surface 24 and towards any of bezel segments 40 to 46. Beam splitter 668 is configured to redirect illumination that is reflected by the retro-reflective surface of bezel segments 40 to 46 to image sensor 664. In this manner, the optical axes of the image sensor 664 and the IR light source 666 are generally aligned. As will be appreciated, by positioning IR light source 666 and image sensor 664 such that their optical axes generally define an acute angle, IR light source 666 and image sensor 664 may be positioned more closely to each other. This advantageously allows imaging assembly 660 to be generally more compact than other imaging assemblies, and to therefore occupy a smaller footprint within interactive board 22 and to be usable with bezels of reduced height.

Although in embodiments described above, the beam splitter is a half-mirror, in other embodiments, the beam splitter may alternatively be a grating.

In the embodiments described above, the imaging assembly comprises a single beam splitter. As will be appreciated, use of a single beam splitter is advantageous as it allows components within the imaging assembly to be compactly arranged. It will also be appreciated that beam splitters are generally simpler and lower in cost than other optical redirecting structures, such as prisms. However, as will be understood, the geometric shape of prisms provides several advantages. For example, a right-angled triangular prism can be aligned accurately in a straightforward manner during system assembly, which can reduce manufacturing costs.

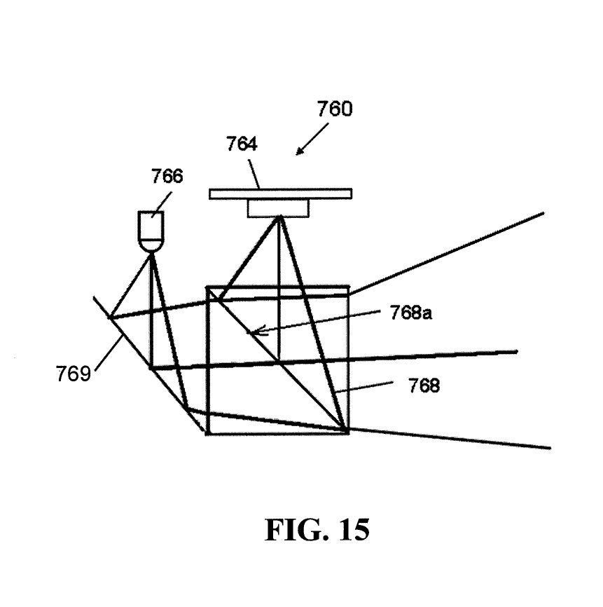

FIG. 15 schematically shows another embodiment of an imaging assembly for use with the interactive input system 20, and which is generally indicated by reference numeral 760. Imaging assembly 760 comprises an IR light source 766 and an image sensor 764 that are oriented such that their optical axes are generally parallel, as shown. Imaging assembly 760 also comprises a mirror 769 positioned generally adjacent to the IR light source 766. Mirror 769 may be any type of mirror, such as for example a planar mirror element or a right-angled triangular prism having a reflective surface. Imaging assembly 760 further comprises a beam splitter 768 positioned adjacent the image sensor 764. In this embodiment, beam splitter 768 is a 50/50 cube beam splitter at the wavelength emitted by the IR light source 766, and comprises a diagonal plane 768a that provides the beam splitting function. Here, mirror 769 is configured to redirect illumination emitted by light source 766 generally across the interactive surface 24 and towards any of bezel segments 40 to 46. Image sensor 764 is positioned such that redirected illumination that is reflected by the retro-reflective surface of bezel segments 40 to 46 will be redirected to image sensor 764. In this manner, the optical axes of IR light source 766 and image sensor 764 are generally aligned. As will be appreciated, the right angles provided by mirror 769 and beam splitter 768 advantageously allow these components to be accurately positioned in a straightforward manner, simplifying construction of imaging assembly 760.

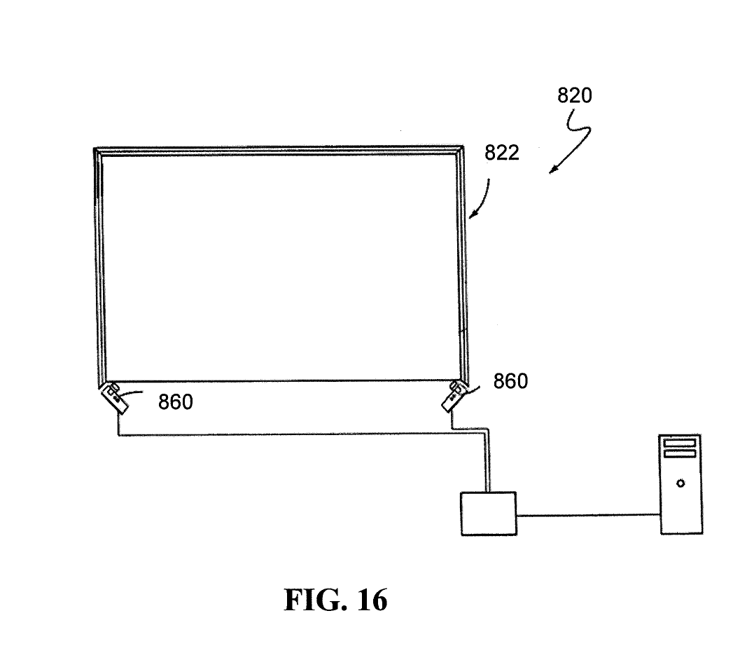

Although in embodiments described above the interactive input system comprises four imaging assemblies, in alternative embodiments, the interactive input system may comprise other numbers of imaging assemblies. For example, in some embodiments, the interactive input system may comprise one (1), two (2), six (6) or more imaging assemblies. For example, FIG. 16 shows another embodiment of an interactive input system, and which is generally indicated by reference numeral 820. Interactive input system 820 is similar to interactive input system 820 described above, however, system 820 comprises an interactive board 822 having two (2) imaging assemblies 860.

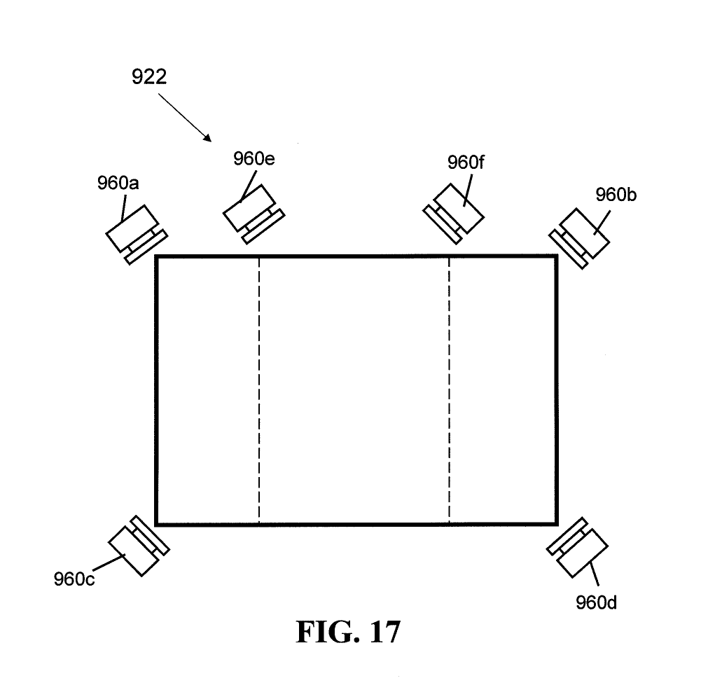

As another example, FIG. 17 shows an another embodiment of an interactive board for use with interactive input system 820, and which is generally indicated using reference numeral 922. Interactive board 922 comprises six (6) imaging assemblies 960a to 960f. Here, imaging assemblies 960a to 960d are positioned adjacent to corners of the interactive surface of the interactive board 922, while imaging assemblies are positioned distant from these corners on an upper edge of the interactive surface. In this embodiment, the field of view of each of the imaging assemblies 960a to 960d is 104 degrees, while the field of view of each of imaging assemblies 960e and 960f is less than 104 degrees, and may be varied according to the position of the imaging assembly. Accordingly, unlike some embodiments described above in which the IR light source of each imaging assembly is configured to provide a “fan-shaped” illumination along the length of the bezel, in this embodiment, the illumination emitted by IR light sources of each of the imaging assemblies 960a to 960f may be varied individually according to the respective field of view of the imaging assembly. In this embodiment, the imaging assembly may be any imaging assembly of the embodiments described above in which the optical axes of the image sensor and the IR light source are generally aligned.

Although in embodiments described above, the IR light source comprises a plurality of IR LEDs arranged along a linear axis, in other embodiments, the IR light source may alternatively comprise a plurality of IR LEDs arranged in other manners.

Although in embodiments described above, the beam splitter is a 50/50 half mirror, in other embodiments, the beam splitting ratio of the beam splitter may alternatively be different.

Although in embodiments described above, the image sensor is a CMOS area image array, in other embodiments, the image sensor may alternatively be any image sensor, such as for example a CCD, a linear sensor, and the like.

Although in embodiments described above, the light source comprises one or more LEDs, in other embodiments, the light source may alternatively comprise another source of light, such as for example a fluorescent source of light.

Although in embodiments described above, the light source comprises a monochromatic IR LED, in other embodiments, the light source may alternatively comprise a LED that emits illumination in one or more other wavelength ranges, and/or may alternatively be used in conjunction with a filter.

Although embodiments have been described above with reference to the accompanying drawings, those of skill in the art will appreciate that variations and modifications may be made without departing from the scope thereof as defined by the appended claims.

What is claimed is:

1. An imaging assembly for an interactive input system comprising:
an image sensor for capturing images of a region of interest;
a light source; and
a beam splitter, wherein the beam splitter is configured such that optical axes of the image sensor and the light source are generally aligned.

2. An imaging assembly according to claim 1, wherein the region of interest is surrounded at least partially by a retro-reflective bezel.

3. An imaging assembly according to claim 1, wherein the light source comprises at least one light emitting diode.

4. An imaging assembly according to claim 1, wherein the light source is an infrared light source.

5. An imaging assembly according to claim 1, further comprising a tuned lens positioned between the light source and the beam splitter.

6. An imaging assembly according to claim 5, wherein the tuned lens is configured to partially collimate illumination emitted by the light source.

7. An imaging assembly according to claim 1, further comprising a diffuser positioned between the light source and the beam splitter.

8. An imaging assembly according to claim 1, wherein the imaging assembly is configured to provide illumination having a fan-shaped profile.

9. An imaging assembly according to claim 1, wherein the optical axes of the image sensor and the light source define an acute angle.

10. An imaging assembly according to claim 1, wherein the beam splitter is any of a half-mirror plate, a customer designed coating plate, a cube beam splitter, and a grating.

11. An imaging assembly according to claim 1, further comprising a two-element lens system.

12. An imaging assembly according to claim 11, wherein the two-element lens system comprises a biconcave lens and a plano-convex lens.

13. An imaging assembly according to claim 1, further comprising a mirror.

14. An imaging assembly according to claim 13, wherein the mirror comprises a right-angled prism.

15. An imaging assembly according to claim 13, wherein the beam splitter is a cube beam splitter.

16. An imaging assembly according to claim 1, wherein the light source is positioned below an interactive surface of the interactive input system.

17. An interactive input system comprising:
at least one imaging assembly comprising:
an image sensor capturing images of a region of interest;
a light source; and
a beam splitter, wherein the beam splitter is configured such that optical axes of the image sensor and the light source are generally aligned.

18. An interactive input system according to claim 17, wherein the region of interest is surrounded at least partially by a retro-reflective bezel.

19. An interactive input system according to claim 17, further comprising processing structure in communication with the image sensor processing captured images for locating a pointer positioned in proximity with the region of interest.

20. An interactive input system according to claim 17, wherein the light source comprises at least one light emitting diode.

21. An interactive input system according to claim 17, wherein the light source is an infrared light source.

22. An interactive input system according to claim 17, wherein the imaging assembly further comprises a tuned lens positioned between the light source and the beam splitter.

23. An interactive input system according to claim 22, wherein the tuned lens is configured to partially collimate illumination emitted by the light source.

24. An interactive input system according to claim 17, wherein the imaging assembly further comprises a diffuser positioned between the light source and the beam splitter.

25. An interactive input system according to claim 17, wherein the imaging assembly is configured to provide illumination having a fan-shaped profile.

26. An interactive input system according to claim 17, wherein the optical axes of the image sensor and the light source define an acute angle.

27. An interactive input system according to claim 17, wherein the beam splitter is any of a half-mirror plate, a custom-designed coating plate, a cube beam splitter, and a grating.

28. An interactive input system according to claim 17, wherein the imaging assembly further comprises a two-element lens system.

29. An interactive input system according to claim 28, wherein the two-element lens system comprises a biconcave lens and a plano-convex lens.

30. An interactive input system according to claim 17, wherein the imaging assembly further comprises of a mirror.

31. An interactive input system according to claim 30, wherein the mirror comprises a right-angled prism.

32. An interactive input system according to claim 30, wherein the beam splitter is a cube beam splitter.

33. An interactive input system according to claim 17, wherein the light source is positioned below an interactive surface of the interactive input system.
